(19) United States
(12) Patent Application Publication
(10) Pub. No.: US 2018/0180571 A1
(43) Pub. Date: Jun. 28, 2018

(54) METHOD FOR MEASURING BORON CONCENTRATION AND APPARATUS FOR CARRYING OUT THE SAME

(71) Applicant: GACHON UNIVERSITY OF INDUSTRY-ACADEMIC COOPERATION FOUNDATION, Seongnam-si (KR)

(72) Inventors: Chung Wung BARK, Seoul (KR); Sang Joon PARK, Hanam-si (KR); Ji Hyeon KIM, Seoul (KR); Jae Hyun HUR, Yongin-si (KR); Il Tae KIM, Seoul (KR); Nguyen Thi Nguyen, Seongnam-si (KR); Ki Ryong MAENG, Seongnam-si (KR); Doo Soo KIM, Seongnam-si (KR)

(21) Appl. No.: 15/415,035

(22) Filed: Jan. 25, 2017

(30) Foreign Application Priority Data
Dec. 22, 2016 (KR) 10-2016-0176631

(51) Int. Cl. G01N 27/413

(52) U.S. Cl. CPC G01N 27/413

(57) ABSTRACT

A method for measuring boron concentration and an apparatus for performing the method are provided. The boron concentration measuring apparatus includes a reaction unit, an injection unit, a power supply unit, an electric current meter, a pH measuring device and an analysis unit to calculate the boron concentration with high reliability by calculating a mole concentration of boron ions through the analysis unit through calculating the titration time and the current amount during the titration time.

### CROSS REFERENCE TO RELATED APPLICATION

This application claims priority from and the benefit of Korean Patent Applications No. 10-2016-0176631, filed on Dec. 22, 2016, which is hereby incorporated by reference for all purposes as if fully set forth herein.

### BACKGROUND OF THE INVENTION

### Field of the Invention

The present invention relates to a method for measuring boron concentration and an apparatus for carrying out the method, more specifically to a method for measuring boron concentration in boric acid solution (H₃BO₃) and an apparatus for carrying out the method.

### Discussion of the Background

Nuclear power generation generates electricity by fission energy of nuclear fuel.

To explain the nuclear fission process of nuclear fuel in more detail, first, nuclear fuel is fissioned by inhaling thermal neutrons in the reactor. At this time, another thermal neutron is discharged from the nuclear fuel.

The released thermal neutrons react with other nuclear fuel in the vicinity, causing fission. Therefore, the nuclear fission of the nuclear fuel proceeds as a chain reaction in the reactor.

During this fission process, nuclear fuel releases more neutrons than before. As a result, the chain reaction of fission is rapidly increased as the number of cycles increases, which can increase the burden on the reactor and cause danger.

For safe and continuous use of nuclear reactors, control materials for controlling the chain reaction of nuclear fission are used in nuclear power generation.

The control material is a material that controls the output of the reactor by controlling the number of neutrons absorbed in the fuel.

Generally, in light-water reactor power generation, boron (B) is used as a reactor control material.

Boron (B) absorbs the thermal neutrons absorbed in the fuel, thereby reducing the number of fission reactions by thermal neutrons and controlling the output of the reactor. Generally, boron (B) is diluted with cooling water in the form of boric acid solution (H₃BO₃) dissolved in water.

Therefore, detecting the boron (B) concentration in boric acid solution (H₃BO₃) may be an essential step for controlling the output of the reactor.

Accordingly, Japanese Patent Publication No. 3606339 (entitled “Concentration Measuring Apparatus: Applicant: SHIKOKU RESEARCH INSTITUTE INC)” discloses a concentration measuring apparatus including an introduction pipe for introducing a liquid sample and a rare gas, a drain pipe through which the liquid sample and the rare gas are circulated, a flow rate control valve for controlling the flow rate of the sample, a light emitting part for emitting the liquid sample, and a detection part for detecting a spectrum emitted from the light emitting portion, thereby measuring the concentration of boron based on the intensity of the emission spectrum of boron.

However, in the conventional boron concentration measuring apparatus, it is difficult to detect when the concentration of the liquid sample is diluted, and reliable measurement may not be possible when the arc discharge occurs in the light emitting portion or when the light is exposed to external light.

### SUMMARY OF THE INVENTION

Accordingly, it is an object of the present invention to provide a high-precision boron concentration measurement method and an apparatus for performing the method.

Another technical problem to be solved by the present invention is to provide a high-efficiency boron concentration measuring method and an apparatus for performing the method.

Another object of the present invention is to provide a method for easily measuring a boron concentration with high reliability and an apparatus for carrying out the method.

Another object of the present invention is to provide a method for measuring a boron concentration with high safety and an apparatus for carrying out the method.

A method for measuring boron concentration, according to an exemplary embodiment of the present invention comprises: introducing boric acid solution (H₃BO₃) into a reaction tank, in which at least a portion of an electrode unit including an oxidation electrode and a reduction electrode is immersed; injecting a first material by an injection unit, which is an electrolyte for dissociating hydrogen ions, into the reaction tank into which the boron-born water (H₃BO₃) has been introduced to prepare the first aqueous solution; injecting a second material which is an electrolyte which forms a precipitate by reacting with the oxidation electrode, the second material having a standard electrode potential that is equal to or lower than about 0.8 V, and a third material which is an electrolyte not participating in a chemical reaction in the reaction tank, into the first aqueous solution to form a second aqueous solution through the injection unit; providing electric current by a power supply unit to electrolyze the second aqueous solution; measuring a concentration of hydrogen ions in the second aqueous solution by time using a pH measuring device during the electrolysis to generate a concentration data; measuring a current amount of the second aqueous solution by time with an electric current meter during the electrolysis to generate a current data; transmitting the concentration data and the current data to an analysis unit; and calculating a concentration of boron based on the concentration data and the current data by the analysis unit.

For example, calculating a concentration of boron, may comprise making a graph of the concentration data measured by the pH measuring device to extract a titration time point corresponding to an inflection point of the graph; making a graph of the current data measured by the electric current meter to extract amounts of current measured until the titration time; calculating amount of charge of the second aqueous solution electrolyzed by integrating the amounts of currents until the titration time; calculating number of moles of free electrons by dividing the amount of charge by a Faraday constant; and coverting the number of moles of free electrons to the boron concentration.

For example, the oxidation electrode may be at least one of silver (Ag), copper (Cu) and zinc (Zn).

For example, the second material may be one selected from the group consisting of sodium bromide (NaBr), sodium chloride (NaCl), potassium chloride (KCl), calcium chloride (CaCl₂), sodium sulfide (Na₂S), potassium sulfide (K₂S), calcium sulfide (CaS), sodium sulfate (Na₂SO₄), potassium sulfate (K₂SO₄), calcium sulfate (CaSO₄), sodium carbonate (Na₂CO₃), potassium carbonate (K₂CO₃), and calcium carbonate (CaCO₃) when the oxidation electrode is silver (Ag), the second material may be one selected from the group consisting of sodium sulfide (Na₂S), potassium sulfide (K₂S), sodium carbonate (Na₂CO₃), potassium carbonate (K₂CO₃), and ammonium carbonate ((NH₄)₂CO₃) when the oxidation electrode is copper (Cu), or the second material may be one selected from the group consisting of sodium sulfide (Na₂S), potassium sulfide (K₂S), ammonium sulfide ((NH₄)₂S), magnesium sulfide (MgS), barium sulfide (BaS) and calcium sulfide (CaS) when the oxidation electrode is zinc (Zn).

For example, the first material may be one selected from the group consisting of d-mannitol, sorbitol, xylitol, erythritol, and isomalt.

For example, a cathode of the power supply unit may be electrically connected to the oxidation electrode and an anode of the power supply unit may be electrically connected to the electric current meter.

For example, the pH measuring device may be at least one of a pH meter and an indicator.

In detail, the pH meter may be used as the pH measuring device when the current is in a range of about 10 mA to about 50 mA, or the indicator may be used as the pH measuring device, when the current is over about 50 mA, and the pH measuring device may further comprise a spectroscope for analyzing the color change of the indicator according to the concentration of hydrogen ions in the boric acid solution (H₃BO₃).

An apparatus for measuring boron concentration according to an exemplary embodiment of the present invention comprises a reaction tank, an injection unit, a power supply unit, an electric current meter, a pH measuring device and an analysis unit. The reaction unit comprises a reaction tank containing boric acid solution (H₃BO₃) introduced from outside, and an electrode unit with an oxidation electrode and a reduction electrode, of which a portion is immersed in the reaction tank. The injection unit injects a first material which is an electrolyte for controlling dissociation of hydrogen ions, a second material which reacts with the oxidation electrode to produce a precipitate, the second material having a standard electrode potential that is equal to or lower than about 0.8 V, and a third material which is an electrolyte not participating in a chemical reaction in the reaction tank, into the reaction tank. The power supply unit supplies a current to the electrode unit to control electrolysis of the second aqueous solution containing the boric acid solution (H₃BO₃) and the first to third materials. The electric current meter measures an amount of current during electrolysis of the second aqueous solution. The pH measuring device measures the concentration of hydrogen ions in the aqueous boric acid (H₃BO₃) in the reaction tank. The analysis unit analyzes measured data from the electric current meter and the pH measuring device to derive the concentration of boron in the boric acid solution (H₃BO₃).

According to the boron concentration measuring method and the apparatus for performing the method according to the embodiments and the experimental examples of the present invention, it is possible to measure the boron concentration with high reliability by applying the chemical formula through which complete reaction is performed in the Coulometric Titration analysis of the analysis unit.

In addition, according to the boron concentration measuring method and the apparatus for performing the method according to the embodiments and the experimental examples of the present invention, it is possible to accurately measure the boron concentration by accurately calculating the neutralization point of the second aqueous solution by the analyzing unit.

In addition, the apparatus for performing the method of the present invention can be applied to a conventional boronometer facility without an additional equipment, thereby realizing low cost real time boron concentration measurement.

Further, according to the boron concentration measuring method and apparatus for performing the same according to the embodiments and the experimental examples of the present invention, it is possible to prevent the malfunction of the measuring equipment due to the ion imbalance by the third material, thereby improving the safety.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention is FIG. 1 is a conceptual diagram for explaining the configurations of a boron concentration measuring apparatus according to an embodiment of the present invention.

FIG. 2 is a flowchart for explaining a boron concentration measurement method according to an embodiment of the present invention.

FIG. 3 is a flowchart for explaining a boron concentration calculating method by the analysis unit in the boron concentration measuring method according to the embodiment of the present invention.

FIG. 4 is a Scanning Electron Microscopy (SEM) image of a carbon rod photographed for verification evaluation of the boron concentration measuring method according to the experimental example of the present invention.

FIG. 5 is an energy-dispersive X-ray spectroscopy (EDS) component analysis image of the carbon rod photographed for verifying evaluation of the boron concentration measuring method according to the experimental example of the present invention.

FIG. 6 is a scanning electron microscope (SEM) image of the carbon rod taken for verifying evaluation of the boron concentration measuring method according to the experimental example of the present invention.

FIG. 7 is an energy-dispersive X-ray spectroscopy (EDS) analysis image of the carbon rod photographed for verifying evaluation of the boron concentration measuring method according to the experimental example of the present invention.

FIG. 8 is a graph of pH measured for verifying evaluation of the boron concentration measurement method according to the experimental example of the present invention.

FIG. 9 is a graph of the current measured for verifying evaluation of the boron concentration measuring method according to the experimental example of the present invention.

### DETAILED DESCRIPTION OF THE ILLUSTRATED EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

FIG. 1 is a conceptual diagram for explaining the configurations of a boron concentration measuring apparatus according to an embodiment of the present invention.

Referring to FIG. 1, the apparatus for measuring boric acid concentration 1000 may include a reaction unit 100, an injection unit 200, a power supply unit 300, an electric current meter 400, a pH measuring device 500, and an analysis unit 600.

The reaction unit 100 may be a space where electrolysis and chemical reaction occur. The reaction unit 100 may include a reaction tank 110 and an electrode unit 150.

The reaction tank 110 may receive at least one of boric acid solution (H₃BO₃), an electrolyte, and a precipitate 235 produced by the combination thereof, which are introduced from the injection unit 200 to be described later.

According to the embodiment, the reaction tank 110 can receive the second aqueous solution and the precipitate 235 to be described later. The second aqueous solution may be a mixture of the aqueous boric acid solution (H₃BO₃) and the first to third materials 210, 230, and 250 described below. The precipitate 235 may be a mixture of the oxidation electrode 151 and the second material 230. The precipitate 235 will be described in more detail referring to the injection unit 200 to be described later.

The electrode unit 150 may be connected to the power supply unit 300 and the electric current meter 400 to form a circuit C. Accordingly, a current generated from the power supply unit 300 can be supplied to the electrode unit 150 through the circuit C.

At least, a portion of the electrode unit 150 may be accommodated in the reaction tank 110. At this time, at least, a portion of the electrode unit 150 may be immersed in the second aqueous solution contained in the reaction tank 110. Accordingly, when current is supplied to the electrode unit 150 immersed in the power supply unit 300, electrolysis can be performed in the second aqueous solution.

The electrode unit 150 may include an oxidation electrode 151 and a reduction electrode 155. The oxidation electrode 151 may be an anode. Accordingly, when power is supplied from the power supply unit 300, an oxidation reaction may occur in the oxidation electrode 151.

More specifically, the oxidation electrode 151 may emit the free electrons (e⁻) and be ionized. The released free electrons (e⁻) may be transferred to the reduction electrode 155, which will be described later, along with the circuit C described above. At this time, the number of free electrons (e⁻) emitted may be equal to the number of hydroxide ions (OH⁻) to be described later.

On the other hand, as described above, the metal cation of the ionized electrode 151 may react with the second material 230 to form the precipitate 235, which will be described later.

The oxidation electrode 151 may be a metal having a standard electrode potential of 0.8 V or less. In other words, the oxidation electrode 151 may be a metal having a good reducing power.

Table 1 below is a standard electrode potential table describing the half-reaction scheme of some metals whose standard electrode potential is 0.8 V or less. Referring to Table 1, the oxidation electrode 151 may be at least one of silver (Ag), copper (Cu), and zinc (Zn).

TABLE 1

| Half-reaction | E⁰ (V) |
|---|---|
| Ag⁺(aq) + e⁻ →Ag(s) | 0.8 |
| Cu²⁺(aq) + 2e⁻ →Cu(s) | 0.34 |
| Sn²⁺(aq) + 2e⁻ →Sn(s) | 0.15 |
| 2H⁺(aq) + 2e⁻ →H₂(g) | 0 |
| Pb²⁺(aq) + 2e⁻ →Pb | −0.13 |
| Zn²⁺(aq) + 2e⁻ →Zn(s) | −0.76 |
| Al³⁺(aq) + 3e⁻ →Al(s) | −1.66 |

According to the embodiment, the oxidation electrode 151 may be silver (Ag). Accordingly, during the electrolysis, the silver (Ag) that is the oxidation electrode 151 can be separated into the free electrons (e⁻) and the silver ions (Ag⁺) (see Chemical Formula 1 below). At this time, the separated free electrons (e⁻) may be transferred to the reduction electrode 155, which will be described later, along the circuit C.

Ag→Ag⁺e⁻ Chemical Formula 1

On the other hand, the silver ion (Ag⁺) may react with bromine ion (Br⁻) present in the second aqueous solution to form a precipitate of silver bromide (AgBr). Here, the bromine ion (Br⁻) may be an anion of sodium bromide (NaBr), which is an example of the second material 230.

The reaction of the oxidation electrode 151 and the second material 230 will be described in more detail with reference to the description of the injection unit 200 to be described later.

The reduction electrode 155 may be a cathode. In addition, the reduction electrode 155 may be a material having low reactivity with water (H₂O). In other words, the reduction electrode 155 may be a material that is not well soluble in water (H₂O). For example, the reduction electrode 155 may be at least one of carbon (C), platinum (Pt), titanium (Ti) and iridium (Ir).

When a current is supplied to the electrode unit 150 by the power supply unit 300 to be described later, a reduction reaction may occur in the reduction electrode 155.

More specifically, the reduction electrode 155 may receive the free electrons (e⁻) emitted from the oxidation electrode 151 when the power source 300 supplies a current. The transferred free electron (e⁻) may be combined with water molecules (H₂O) distributed around the reduction electrode 155 to perform a reduction reaction (see Chemical Formula 2 below).

H₂O+e⁻→½H₂+OH⁻ Chemical Formula 2

As the product of the reduction reaction, hydrogen gas (H₂) and hydroxide ion (OH⁻) may be generated. The hydroxide ion (OH⁻) may perform a neutralization reaction with the hydrogen ion (H⁺) dissociated by the reaction of the aqueous boric acid solution (H₃BO₃) and the first material 210 described below. At this time, the hydroxide ion (OH⁻) and the completely dissociated hydrogen ion (H⁺) may be completely reacted. Therefore, when the second aqueous solution is completely neutralized, the amount of the hydroxide ion (OH⁻) may be equal to the amount of the completely dissociated hydrogen ion (H⁺).

The injection unit 200 may receive the first material 210, the second material 230 and the third material 250.

The injection unit 200 may be connected to at least a part of the reaction tank 110. Accordingly, the first to third materials 210, 230, and 250 contained in the injection unit 200 can be injected into the reaction tank 110.

The first material 210 may be chemically reacted with the boric acid solution (H₃BO₃) when injected into the reaction tank 110, as described above. The hydrogen ion (H⁺) may be dissociated from the boric acid solution (H₃BO₃) by the chemical reaction.

In other words, the first material 210 may be a substance that helps ionizing of the hydrogen ions (H⁺) from the boric acid solution (H₃BO₃). At this time, the concentration of the first material 210 injected into the reaction tank 110 may be in a range of at least 2 times the concentration of the boric acid solution (H₃BO₃) to 10 times the concentration of the boric acid solution (H₃BO₃). Accordingly, the boric acid solution (H₃BO₃) can sufficiently receive the hydroxyl group (OH⁻) from the first material 210. Therefore, the hydrogen ion (H⁺) can be completely disassociated from the boric acid solution (H₃BO₃) without being recombined.

At this time, the dissociated hydrogen ion (H⁺) formation ratio may be the same as the reaction ratio of the boric acid solution (H₃BO₃). Therefore, the boron (B) concentration in the boric acid solution (H₃BO₃) may correspond to the concentration of the hydrogen ion (H⁺).

As described above, the dissociated hydrogen ion (H⁺) can be completely reacted with the hydroxide ion (OH⁻) generated by the reduction reaction of the reduction electrode 155. Accordingly, the second aqueous solution can be neutralized.

Therefore, the boron concentration measuring apparatus 1000 according to the embodiment of the present invention can calculate the concentration of the boron (B) by calculating the reaction concentration of the hydroxide ion (OH⁻) at the time when the hydrogen ion (H⁺) is completely neutralized. The process of calculating the concentration of the hydroxide ion (OH⁻) will be described in more detail referring to the analysis unit 600 described later.

The first material 210 may be at least one of d-mannitol, sorbitol, xylitol, erythritol, or isomalt. According to an embodiment, the first material 210 may be d-mannitol.

The second material 230 may be an electrolyte. Accordingly, it can exist in the ionic state in the second aqueous solution.

The anion (−) of the second material 230 may be combined with the cation (+) of the oxidation electrode 151 in the reaction tank 110. In other words, as described above, the second material 230 may react with the oxidation electrode 151 to generate the precipitate 235.

Generally, in the conventional electrolysis using an oxidation electrode and a reduction electrode, the free electrons (e⁻) emitted from the oxidation electrode migrate to the reduction electrode and recombine with the cation (+) formed by ionizing of the oxidation electrode. As a result, foreign matter has been deposited on the surface of the conventional reduction electrode. However, the apparatus for measuring boron concentration 1000 according to an embodiment of the present invention can prevent recombination of the free electrons (e⁻) and metal cation by injecting the second material 230 in to the reaction tank 110. Therefore, the concentration of the hydroxide ion (OH⁻) can be derived by calculating the number of free electrons (e⁻) through Coulometric Titration analysis, since the total amount of the free electrons (e⁻) participates in the reduction reaction of the reduction electrode 155.

According to the embodiment, when the oxidation electrode 151 is silver (Ag), the second material 230 may be sodium bromide (NaBr). The sodium bromide (NaBr) can be decomposed into sodium ion (Na⁺) and bromide ion (Br⁻) in the second aqueous solution.

The bromine ion (Br⁻) which is an anion may be combined with the silver ion (Ag⁺). Thus, silver bromide (AgBr), which is the precipitate 235, can be produced (see Chemical Formula 3 below).

Ag⁺+Br⁻→AgBr Chemical Formula 3

On the other hand, the cationic sodium ion (Na⁺) can maintain a stabilized state in the second aqueous solution. In other words, the sodium ion (Na⁺) may not react with other ions in the second aqueous solution while maintaining the ionic state.

As described above, the second material 230 may combine with the oxidation electrode 151 to produce the precipitate 235. Accordingly, the kind of the second material 230 may vary depending on the kind of the oxidation electrode 151.

According to one embodiment, when the oxidation electrode 151 is silver (Ag), the second material 230 may be at least one selected from the group consisting of sodium bromide (NaBr), sodium chloride (NaCl), potassium chloride (KCl), calcium chloride (CaCl₂), sodium sulfide (Na₂S), potassium sulfide (K₂S), calcium sulfide (CaS), sodium sulfate (Na₂SO₄), potassium sulfate (K₂SO₄), calcium sulfate (CaSO₄), sodium carbonate (Na₂CO₃), potassium carbonate (K₂CO₃), and calcium carbonate (CaCO₃).

According to another embodiment, when the oxidation electrode 151 is copper (Cu), the second material 230 may be at least one selected from the group consisting of sodium sulfide (Na₂S), potassium sulfide (K₂S), sodium carbonate (Na₂CO₃), potassium carbonate (K₂CO₃), and ammonium carbonate ((NH₄)₂CO₃).

According to another embodiment, when the oxidation electrode 151 is zinc (Zn), the second material 230 may be at least one selected from the group consisting of sodium sulfide (Na₂S), potassium sulfide (K₂S), ammonium sulfide ((NH₄)₂S), magnesium sulfide (MgS), barium sulfide (BaS) and calcium sulfide (CaS).

The third material 250 may be a material for eliminating ion imbalance generated in the second aqueous solution.

More specifically, the third material 250 may be an electrolyte. Accordingly, when the third material 250 is injected into the reaction tank 110, the third material 250 can be completely ionized in the second aqueous solution.

The ionized third material 250 may be in a stable state in the second aqueous solution. Accordingly, when the anion (−) present in the second aqueous solution is reduced by the combination of the cation (+) of the oxidation electrode 151 and the anion (−) of the second material 230, the ion imbalance may be eliminated by the anion of the third material 250 in a stable state. Thus, abrupt interruption of electrolysis can be prevented.

As a conventional technique for preventing the ion imbalance from occurring, there is a method using a salt bridge. However, the ion exchange method using the salt bridge requires a plurality of reaction tanks each accommodating an oxidation electrode and a reduction electrode, thereby increasing the size of the equipment and increasing the cost.

Above all, when the ions pass through the salt bridge, the traveling speed of the ions can be lowered. Accordingly, it takes a long time to measure the concentration of boron (B), and measurement of the real time boron (B) concentration in the reactor may be unsuitable.

However, the apparatus for measuring boron concentration 1000 according to an embodiment of the present invention injects a third material 250 that is completely ionized in a stable state in the second aqueous solution as described above, so that it is possible to prevent ion unbalance in the second aqueous solution, thereby preventing unintentional interruption of electrolysis.

Also, the cations and the anions ionized from the third material 250 are freely moved in the reaction tank 110 in which the electrode unit 150 is commonly accommodated, so that current flow is smooth and it is suitable for real-time boron (B) concentration measurement.

The power supply unit 300 may be a device for supplying a current to the second aqueous solution through the circuit (C). In other words, the second aqueous solution can be electrolyzed by the power supply unit 300.

More specifically, when power is supplied to the oxidation electrode 151 by the power supply unit 300, an oxidation reaction may occur in the oxidation electrode 151 which is an anode.

Also, when power is supplied to the reduction electrode 155 by the power supply unit 300, a reduction reaction may occur at the reduction electrode 155, which is a cathode. At this time, the oxidation reaction and the reduction reaction may proceed at the same time.

The power supply unit 300 may have an electric isolation function. Accordingly, when power is supplied to the power supply unit 300, the interference of the electric field generated between the oxidation electrode 151 and the reduction electrode 155 can be minimized.

The power supply unit 300 may be at least one of a power supply, a battery, or a battery-powered pH measuring device coupled to the pH measuring device 500, which will be described later. According to the embodiment, the power supply unit 300 may be a battery.

The current measurer 400 can measure the amount of current (i) supplied from the power supply unit 300 in real time. The current data measured from the electric current meter 400 may be transmitted to the analysis unit 600.

The electric current meter 400 may be a device for detecting the amount of charge Q at a proper time (t), which is a neutralization point of the second aqueous solution. The method of calculating the amount of charge Q will be described more specifically in the analysis unit 600 described later.

The current measurement range of the current measuring device 400 may be in a range of about 10 mA to about 50 mA. The type of the pH measuring device 500 to be described later may be changed according to the current measurement range of the electric current meter 400. This will be described in more detail in the description of the pH measuring device 500.

At least a portion of the pH measuring device 500 may be immersed in the second aqueous solution. Accordingly, the pH measuring device 500 can measure a change in pH concentration in the second aqueous solution in real time. At this time, the concentration data measured from the pH measuring device 500 may be transmitted to the analysis unit 600, like the electric current meter 400 does as described above.

The pH measuring device 500 may be used to derive a titration time (t), which is a neutralization point of the second aqueous solution. The method of deriving the titration time point (t) will be described in more detail referring to the analysis unit 600, which will be described later.

As described above, the type of the pH measuring device 500 may be determined according to the current measurement range of the electric current meter 400.

According to one embodiment, when the current measurement range is in a range of about 10 mA to about 50 mA, the pH meter may be used as the pH measuring device 500.

According to another embodiment, when the current measurement range is more than about 50 mA, an indicator may be used as the pH measuring device 500. For example, the indicator may be at least one of bromothymol blue, methyl red, phenol red, or o-cresol red.

When the indicator is used as the pH measuring device 500, the pH measuring device 500 may further include a spectroscope for analyzing a color change of the indicator. For example, the spectrometer may be capable of real-time monitoring and measurement by a UV-vis spectrophotometer or a Raman spectroscopic method.

The pH measuring device 500 may have an electric isolation function, such as the power supply unit 300 described above. Accordingly, it is possible to prevent the data from being distorted by the interference of the electric field generated from the oxidation electrode 151 and the reduction electrode 155 when the pH measuring device 500 measures data.

The analysis unit 600 may perform a Coulometric titration analysis at the neutralization point of the second aqueous solution, based on the data transmitted from the electric current meter 400 and the pH measuring device 500.

In other words, the analysis unit 600 calculates the amount of charge Q generated by the electrolysis at the titration time (t) at which the second aqueous solution is completely neutralized, thereby calculating the amount of boron (B) in the boron-containing water (H₃BO₃) inflows outside.

The analysis unit 600 may include a first calculator 610, a second calculator 630, a third calculator 650 and a fourth calculator 670.

The first calculator 610 may make a graph of the current data transmitted from the electric current meter 400 and the concentration data transmitted from the pH measuring device 500. In other words, the first calculator 610 may transform the current data and the concentration data into a pH graph and a current graph, respectively.

Then, the first calculator 610 can derive the titration time (t) at which the second aqueous solution is completely neutralized from the pH graph. More specifically, the titration time point (t) may coincide with the time point at which the pH graph has an inflection point. Therefore, the first calculating unit 610 can extract the inflection point through the second derivative of the pH graph to derive the titration time (t).

The second calculator 630 may calculate the amount of charge (Q) generated during the titration time (t), based on the current graph and the titration time (t).

The charge amount (Q) can be calculated by multiplying or integrating the amount of current (i) generated during the titration time (t) on the basis of the current graph (see Equation 1 below).

Q=i×t=∫₀^{t}i(t)dt Equation 1

Q: Charge amount (C)

I: Current Amount (A)

T: The titration time (t)

According to the embodiment, in the apparatus for measuring boron concentration 1000, a substance to be precipitated on the reduction electrode surface during the reduction reaction is non-existent, and by the stabilized ion distribution in the second aqueous solution, the graph form can be maintained. Accordingly, the second calculator 630 may calculate the charge amount (Q) by multiplying the titration time (t) and the current amount (i).

The third calculator 650 may calculate the number of moles of the free electrons (e⁻) on the basis of the amount of charge (Q). More specifically, the number of moles of the free electrons (e⁻) can be calculated by dividing the quantity of charge (Q) by a Faraday constant (F) (see Equation 2 below).

$${e}^{-} = \frac{Q}{F} = \frac{Q}{96500} \qquad Equation 2$$

e⁻: Free electron (mole)

Q: Charge amount (C)

F: Faraday constant

The fourth calculator 670 can derive the concentration of the boron (B) in the boric acid solution (H₃BO₃) based on the calculated number of moles of the free electrons (e⁻).

More precisely, the titration time (t) may be determined by the time at which the hydrogen ion (H⁺) which is completely dissociated by the reaction between the boron H₃BO₃ and the first material 210, and the hydroxyl ion (OH⁻) generated during the reduction reaction of the reduction electrode 155 are completely neutralized. Therefore, as described with reference to Chemical Formula 2 above, the number of moles of the free electrons (e⁻) generated during the titration time (t) may correspond to the concentration of the hydroxide ions (OH⁻) generated during the reduction reaction of the reduction electrode 155 and the concentration of the hydrogen ion (H⁺) completely reacting with the hydroxide ions (OH⁻).

At this time, the hydrogen ion (H⁺) may be completely dissociated at the same coefficient ratio as the reaction ratio of the boric acid solution (H₃BO₃). Consequently, as a result, the number of moles of the free electron (e⁻) can be converted to the concentration of boron (B).

Hereinbefore, the structures of the apparatus for measuring boron concentration according to the embodiments of the present invention have been described above. The boron concentration measuring apparatus includes the reaction unit, the injection unit, the power supply unit, the electric current meter, the pH measuring device and the analysis unit to measure the concentration of boron (B) in boric acid solution (H₃BO₃) at the titration time (t) through Coulometric titration analysis.

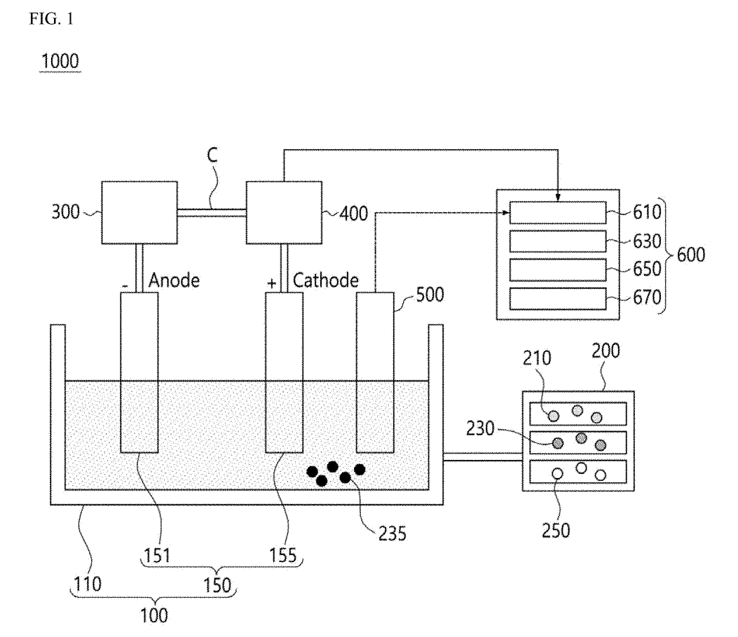

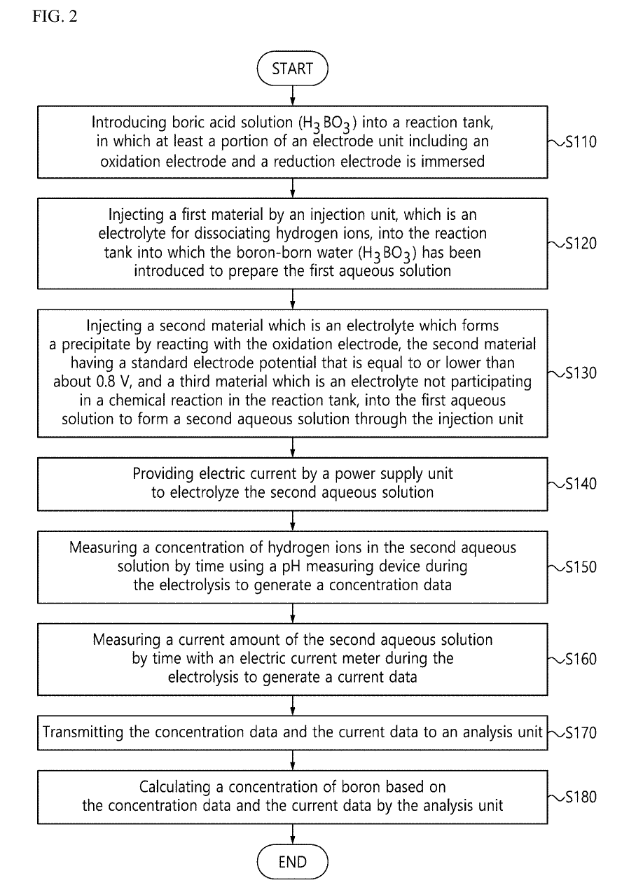

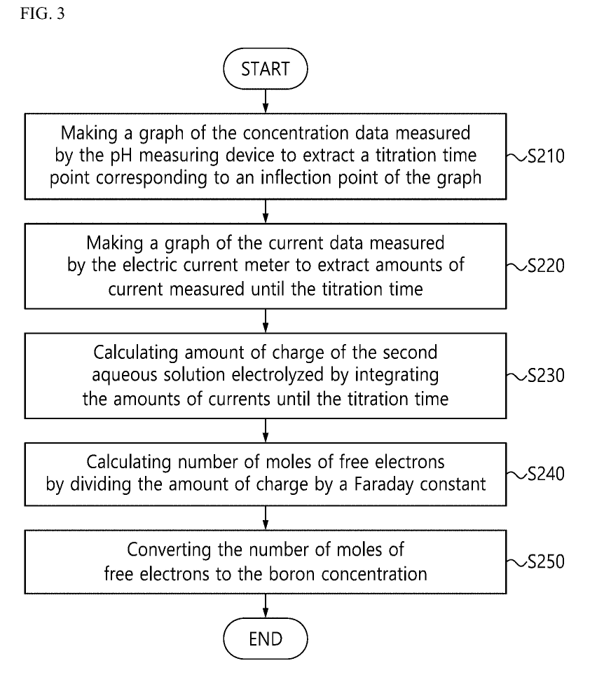

Hereinafter, a boron concentration measuring method according to the above-described embodiment of the present invention will be described with reference to FIGS. 2 and 3.

FIG. 2 is a flowchart for explaining a boron concentration measurement method according to an embodiment of the present invention.

Referring to FIGS. 1 and 2, the boric acid solution (H₃BO₃) may be introduced into the reaction tank 110 (step S110). At this time, the boric acid solution (H₃BO₃) may be injected until at least some of the oxidation electrode 151 and the reduction electrode 155 are immersed.

Then, the first material 210 may be injected into the reaction tank 110 containing the boric acid solution (H₃BO₃) to produce the first aqueous solution (step S120). The first material 210 may react with the boric acid solution (H₃BO₃) in the first aqueous solution to dissociate the hydrogen ions (H⁺).

At this time, the first material 210 may be excessively injected into the reaction tank 110. More specifically, the molar concentration (M) of the first material 210 injected into the reaction tank 110 may be in a range of two times the molar concentration (M) of the boric acid solution (H₃BO₃) to ten times the molar concentration (M) of the boric acid solution (H₃BO₃). Accordingly, the hydrogen ion (H⁺) can be completely dissociated during the reaction between the boric acid solution (H₃BO₃) and the first material 210.

Then, the second material 230 and the third materials 250 are injected into the first aqueous solution to produce a second aqueous solution (step S130). The second material 230 and the third material 250 may be dissociated in the first aqueous solution.

A current may be supplied from the power supply unit 300 to the circuit (C). When electric current is supplied from the power supply unit 300, electrolysis may be performed in the second aqueous solution (step S140).

During the electrolysis, the pH measuring device 500 may be operated to measure the concentration of the hydrogen ion (H⁺) in the second aqueous solution (step S150).

Simultaneously with the measurement of the pH measuring device 500, the electric current meter 400 may be operated to measure the current amount (i) of the second aqueous solution with respect to time (step S160).

The power source of the power supply unit 300 may be cut off after a predetermined time. Thereafter, the measured data from the electric current meter 400 and the pH measuring device 500 may be transmitted to the analysis unit 600 (step S170).

The analysis unit 600 may calculate the concentration of boron based on the received concentration data and the current data (step S180).

FIG. 3 is a flowchart for explaining a boron concentration calculating method by the analysis unit in the boron concentration measuring method according to the embodiment of the present invention.

Referring to FIGS. 1 to 3, the analysis unit 600 may make the concentration data of the hydrogen ions (H⁺) measured by the pH measuring device 500 by time (step S210), and a graph of the current data measured from the electric current meter 400 (step S220). At this time, the pH graph may represent a neutralized titration graph in which the pH concentration changes from acidic to basic through neutral.

Then, the titration time point (t) may be extracted from the pH graph. As described with reference to FIG. 1, the titration time point (t) may be extracted through a second derivative of the pH graph as a point at which an inflection occurs.

If the titration time (t) is extracted, the charge amount (Q) may be calculated by multiplying or integrating the amount of current (i) measured during the titration time (t) from the current graph (step S230).

The calculated charge amount (Q) may be divided by the Fourier series constant (F) to calculate the number of moles of the free electrons (e⁻) (step S240).

As described with reference to FIG. 1, the number of moles of the free electrons (e⁻) may correspond to the concentration of the hydroxide ions (OH⁻), the concentration of the hydrogen ions (H⁺) and the concentration of the boric acid solution (H₃BO₃). Therefore, the number of moles of the free electrons (e⁻) can be converted into the concentration of the boron (B) in the boric acid solution (H₃BO₃) (step S250).

Hereinbefore, the boron concentration measuring method according to the embodiment of the present invention has been described above.

Hereinafter, verification test results of the boron concentration measuring method according to the experimental example of the present invention described above will be described.

The Measurement of the Boron Concentration According to the Experimental Example of the Present Invention

0.572 g of boric acid and 8.426 g (0.046 mole) of d-mannitol were dissolved in 100 ml of DI (Deionized) Water to prepare a first aqueous solution.

50 ml of DI (Deionized) Water was added to 500 μl of the prepared first aqueous solution, and the mixture was stirred for 30 minutes.

0.257 g (0.05M) of sodium bromide (NaBr) was prepared as the second material, and 0.505 g (0.10M) of potassium nitrate (KNO₃) was prepared as the third material.

0.257 g (0.05 M) of sodium bromide (NaBr) and 0.505 g (0.10 M) of potassium nitrate (KNO₃) were mixed in the first aqueous solution to prepare a second aqueous solution.

A silver metal plate of 50 mm (L)×15 mm (H⁺)×0.1 mm (T), which is an oxidation electrode, and a graphite rod of 5 mm (D)×30 mm (L), which is a reduction electrode, are immersed for about 15 mm.

4.8V DC power was supplied to a metal plate and a graphite rod, and the current was measured with a digital multimeter by setting the current output to 30 mA.

At the same time as the current amount measurement, the pH concentration of the second aqueous solution was measured with a pH measuring device.

After the elapse of 500 seconds (sec) after the measurement of the current amount and the pH concentration of the second aqueous solution, the DC power supply was turned off. The boron concentration in the second aqueous solution was then analyzed via a computer.

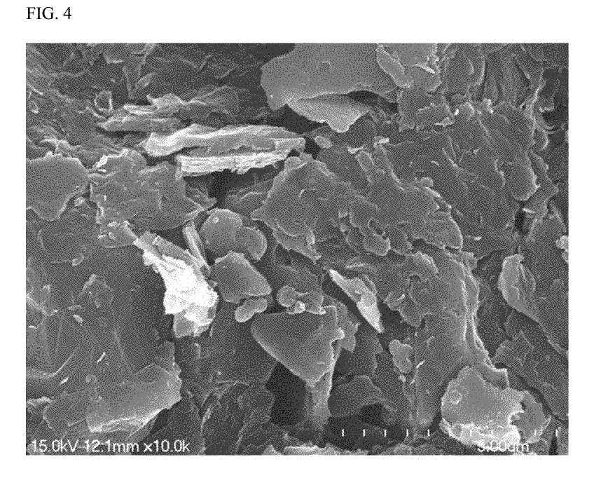

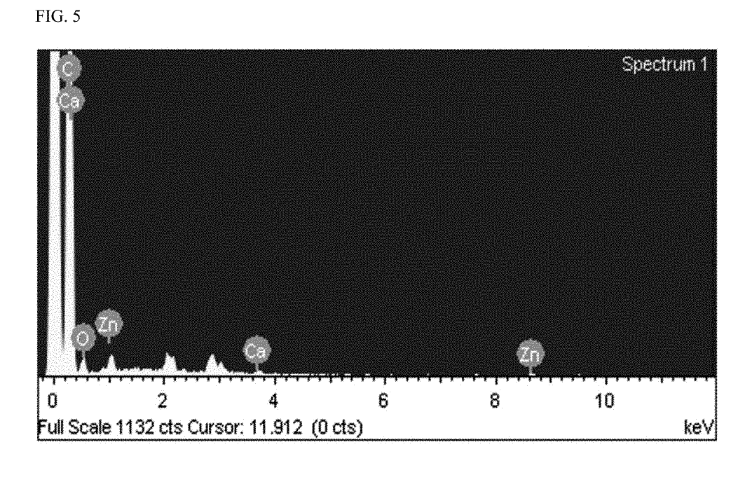

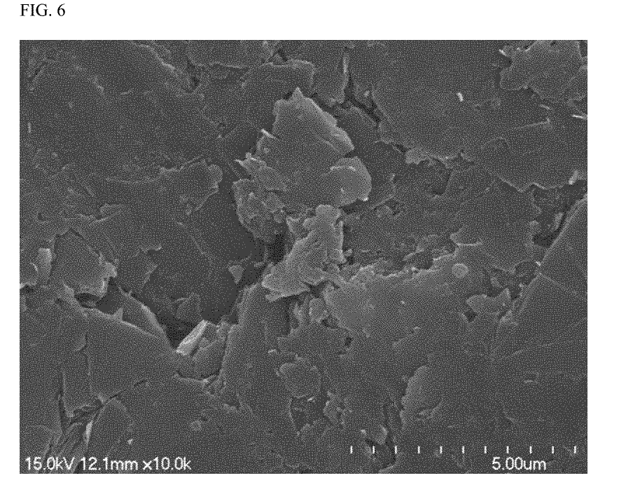

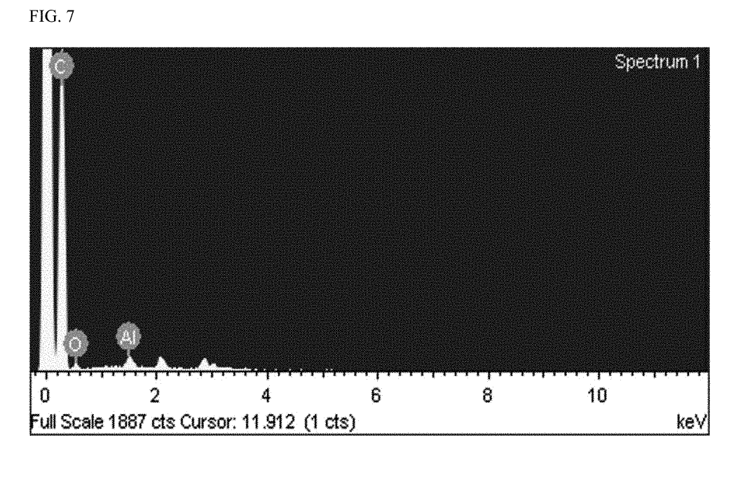

FIGS. 4 to 7 are SEM (Scanning Electron Microscopy) images and Energy-dispersive X-ray spectroscopy (EDS) images of the carbon rods taken for verifying evaluation of the boron concentration measuring method according to the experimental example of the present invention. More specifically, FIG. 4 is a scanning electron microscopy (SEM) image obtained before electrolysis of the second aqueous solution, FIG. 5 is an Energy-dispersive X-ray spectroscopy (EDS) image obtained before electrolysis of the second aqueous solution, FIG. 6 is an SEM (Scanning Electron Microscopy) image obtained after electrolysis of the second aqueous solution, and FIG. 7 is an Energy-dispersive X-ray spectroscopy (EDS) image obtained after electrolysis of the second aqueous solution.

Referring to FIGS. 4 to 7, in the energy-dispersive X-ray spectroscopy (EDS) component analysis of the graphite rod, silver (Ag) is not detected in the graphite rod regardless of the electrolysis. Therefore, the silver (Ag) ion ionized from the silver (Ag) metal sheet by the electrolysis of the second aqueous solution is not recombined with the free electron (e⁻) described with reference to FIG. 1, but reacts with anion bromide (Br) of sodium bromide (NaBr) to generate a precipitate of silver bromide (AgBr).

In other words, it can be seen that the free electrons (e⁻) emitted from the Ag metal plate are used for the reduction reaction of the graphite rod.

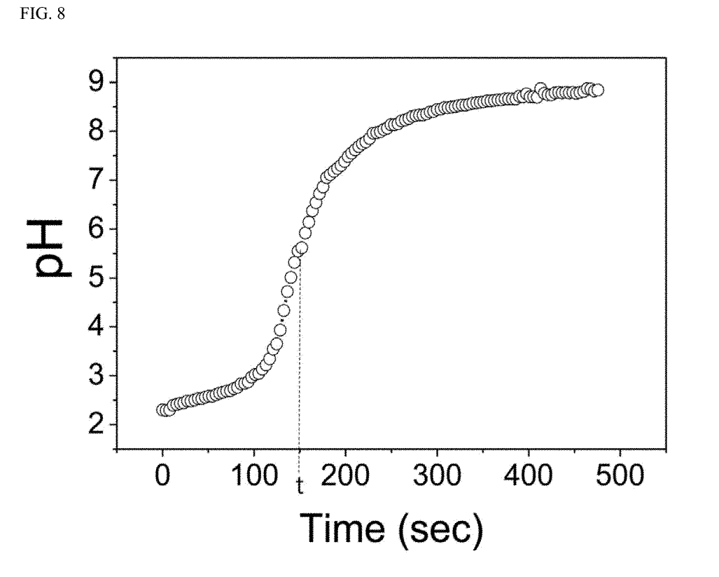

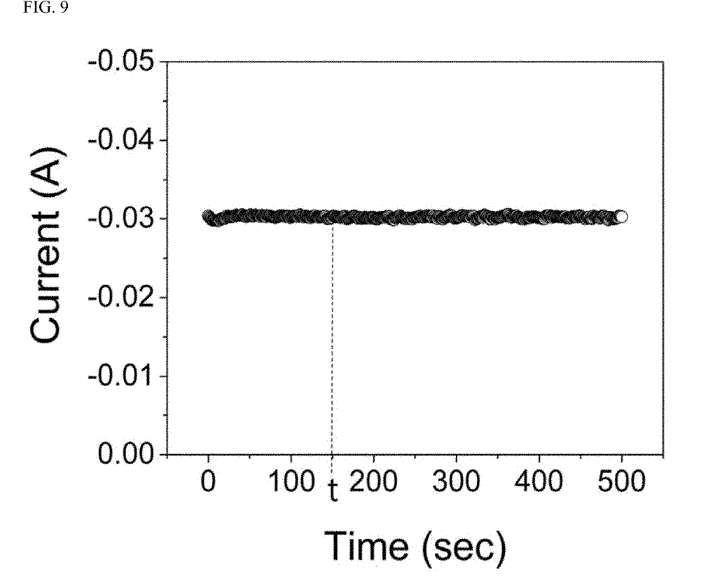

FIGS. 8 and 9 are graphs of data measured during the electrolysis of the second aqueous solution for verifying evaluation of the boron concentration measuring method according to the experimental example of the present invention. More specifically, FIG. 8 is a graph of a pH obtained by visualizing concentration data measured by time through the pH measuring device, and FIG. 9 is a graph of current obtained by visualizing current data measured from the electric current meter.

Referring to FIGS. 1 to 9, in the boron concentration measuring method according to the experimental example of the present invention, the concentration of boron (B) can be calculated based on the titration time point (t) when the second aqueous solution is neutralized and the current amount (i) measured at the titration time point (t).

As can be seen in FIG. 8, the results of the data analysis by the boron concentration measuring method according to the experimental example of the present invention confirmed that the pH graph was distorted at 150 seconds after the electrolysis proceeded. In other words, it can be confirmed that the titration time (t) at which the second aqueous solution is neutralized is 150 seconds (sec).

In addition, it can be seen from the current graph shown in FIG. 9 that the amount of current (i) at the titration time (t) of 150 seconds (sec) is 30 mA.

Based on the measured titration time point (t) and the current amount (i), the charge amount (Q) calculated through the analysis unit 600 was 4.5 C, and the mole of the free electron (e⁻) was 4.66×10⁻⁵ mole.

Accordingly, it can be confirmed that the molar number of the boron (B) measured by the boron concentration measuring method according to the experimental example of the present invention is 4.66×10⁻⁵ mole.

When the molar number of boron (B) calculated for comparison with the concentration of boron (B) initially charged in 100 ml of DI (Deionized) Water is converted to the molar concentration (M), the concentration (M) is 0.0925M.

More specifically, the second aqueous solution containing 4.66×10⁻⁵ moles of boron (B) calculated according to the Experimental Example of the present invention is prepared by diluting the initially prepared first aqueous solution by two hundred times. When the molar concentration (M) of the boron (B) is calculated in consideration of this, it can be confirmed that 0.0925M is derived.

Therefore, it can be confirmed that the molar concentration (M) of boron (B) calculated through the experiment agrees with the molar concentration (M) of boron (B) initially introduced into the first aqueous solution.

Hereinbefore, the boron concentration measuring method according to the embodiments and the experimental examples of the present invention and the apparatus for performing the method are described above. The boron concentration measuring apparatus according to the embodiments and the experimental examples of the present invention include the reaction unit, the injection unit, the power supply unit, the electric current meter, the pH measuring device and the analysis unit to calculate the boron concentration with high reliability by calculating a mole concentration of boron ions through the analysis unit through calculating the titration time (t) and the current amount (i) during the titration time (t).

Further, the boron concentration measuring apparatus according to an embodiment of the present invention can be easily applied to a boronometer installed in a reactor without changing any equipment, thereby enabling real-time measurement of boron (B) concentration used as a moderator of a reactor.

It will be apparent to those skilled in the art that various modifications and variation may be made in the present invention without departing from the spirit or scope of the invention. Thus, it is intended that the present invention cover the modifications and variations of this invention provided they come within the scope of the appended claims and their equivalents.

What is claimed is:

1. A method for measuring boron concentration, comprising:
introducing boric acid solution (H₃BO₃) into a reaction tank, in which at least a portion of an electrode unit including an oxidation electrode and a reduction electrode is immersed;
injecting a first material by an injection unit, which is an electrolyte for dissociating hydrogen ions, into the reaction tank into which the boron-born water (H₃BO₃) has been introduced to prepare the first aqueous solution;
injecting a second material which is an electrolyte which forms a precipitate by reacting with the oxidation electrode, the second material having a standard electrode potential that is equal to or lower than about 0.8 V, and a third material which is an electrolyte not participating in a chemical reaction in the reaction tank, into the first aqueous solution to form a second aqueous solution through the injection unit;
providing electric current by a power supply unit to electrolyze the second aqueous solution;
measuring a concentration of hydrogen ions in the second aqueous solution by time using a pH measuring device during the electrolysis to generate a concentration data;
measuring a current amount of the second aqueous solution by time with an electric current meter during the electrolysis to generate a current data;
transmitting the concentration data and the current data to an analysis unit; and
calculating a concentration of boron based on the concentration data and the current data by the analysis unit.

2. The method of claim 1, wherein calculating a concentration of boron, comprises:
making a graph of the concentration data measured by the pH measuring device to extract a titration time point corresponding to an inflection point of the graph;
making a graph of the current data measured by the electric current meter to extract amounts of current measured until the titration time;
calculating amount of charge of the second aqueous solution electrolyzed by integrating the amounts of currents until the titration time;
calculating number of moles of free electrons by dividing the amount of charge by a Faraday constant; and
converting the number of moles of free electrons to the boron concentration.

3. The method of claim 1, wherein the oxidation electrode is at least one of silver (Ag), copper (Cu) and zinc (Zn).

4. The method of claim 3, the second material is one selected from the group consisting of sodium bromide (NaBr), sodium chloride (NaCl), potassium chloride (KCl), calcium chloride (CaCl₂), sodium sulfide (Na₂S), potassium sulfide (K₂S), calcium sulfide (CaS), sodium sulfate (Na₂SO₄), potassium sulfate (K₂SO₄), calcium sulfate (CaSO₄), sodium carbonate (Na₂CO₃), potassium carbonate (K₂CO₃), and calcium carbonate (CaCO₃) when the oxidation electrode is silver (Ag),
the second material is one selected from the group consisting of sodium sulfide (Na₂S), potassium sulfide (K₂S), sodium carbonate (Na₂CO₃), potassium carbonate (K₂CO₃), and ammonium carbonate ((NH₄)₂CO₃) when the oxidation electrode is copper (Cu), or
the second material is one selected from the group consisting of sodium sulfide (Na₂S), potassium sulfide (K₂S), ammonium sulfide ((NH₄)₂S), magnesium sulfide (MgS), barium sulfide (BaS) and calcium sulfide (CaS) when the oxidation electrode is zinc (Zn).

5. The method of claim 1, wherein the first material is one selected from the group consisting of d-mannitol, sorbitol, xylitol, erythritol, and isomalt.

6. The method of claim 1, wherein a cathode of the power supply unit is electrically connected to the oxidation electrode and an anode of the power supply unit is electrically connected to the electric current meter.

7. The method of claim 1, wherein the pH measuring device is at least one of a pH meter and an indicator.

8. The method of claim 7, wherein the pH meter is used as the pH measuring device when the current is in a range of about 10 mA to about 50 mA.

9. The method of claim 7, wherein the indicator is used as the pH measuring device, when the current is over about 50 mA, and
the pH measuring device further comprises a spectroscope for analyzing the color change of the indicator according to the concentration of hydrogen ions in the boric acid solution (H₃BO₃).

10. An apparatus for measuring boron concentration, comprising:
a reaction unit comprising a reaction tank containing boric acid solution (H₃BO₃) introduced from outside, and an electrode unit with an oxidation electrode and a reduction electrode, of which a portion is immersed in the reaction tank;
an injection unit injecting a first material which is an electrolyte for controlling dissociation of hydrogen ions, a second material which reacts with the oxidation electrode to produce a precipitate, the second material having a standard electrode potential that is equal to or lower than about 0.8 V, and a third material which is an electrolyte not participating in a chemical reaction in the reaction tank, into the reaction tank;
a power supply unit supplying a current to the electrode unit to control electrolysis of the second aqueous solution containing the boric acid solution (H₃BO₃) and the first to third materials;
an electric current meter measuring an amount of current during electrolysis of the second aqueous solution;
a pH measuring device measuring the concentration of hydrogen ions in the aqueous boric acid (H₃BO₃) in the reaction tank; and
an analysis unit analyzing measured data from the electric current meter and the pH measuring device to derive the concentration of boron in the boric acid solution (H₃BO₃).
